(19) United States
(12) Patent Application Publication
(10) Pub. No.: US 2022/0396130 A1
(43) Pub. Date: Dec. 15, 2022

(54) CANOPY FOR A VEHICLE

(71) Applicant: Tuff Tonneaus Wholesale Pty Ltd, Bayswater (AU)

(72) Inventors: Nicholas Arthur, Bayswater (AU); Sam Bickford, Bayswater (AU)

(73) Assignee: Tuff Tonneaus Wholesale Pty Ltd, Bayswater (AU)

(21) Appl. No.: 17/836,946

(22) Filed: Jun. 9, 2022

(30) Foreign Application Priority Data
Jun. 9, 2021 (AU) 2021103237

(51) Int. Cl. B60J 7/10; B60R 9/06

(52) U.S. Cl. CPC B60J 7/106; B60R 9/065

(57) ABSTRACT

A canopy system may comprise a frame mountable to the vehicle so as to extend over the tray of the vehicle; a cover, the cover may be configured to extend over the frame. The frame may have supports configured to attach to the vehicle. The cover may be attachable to at least one of the supports of the frame and may have a roof portion, a front portion, opposing side portions and a rear portion. At least one of the opposing side portions and the rear portion may be partially detachable from the cover to provide access to the tray of the vehicle. The supports may have bracket members attached to ends thereof and the bracket members may be configured to be supported on top of side walls of the vehicle. The bracket members may be attached to an inner surface of the side walls of the vehicle.

### CROSS-REFERENCE TO RELATED APPLICATIONS

This application claims priority to Australian Patent Application No. 2021103237, filed on Jun. 9, 2021. The contents of which are incorporated herein by reference.

### FIELD OF THE PRESENT DISCLOSURE

The present invention relates generally to a canopy system for a vehicle, and in particular, to a soft canopy system for enclosing a tray or cargo area of a vehicle.

### BACKGROUND

A variety of covers or canopies have been proposed to convert an open tray or tonneau of a vehicle into an enclosed space. Such covers or canopies may be in the form of a hard or soft material that attaches to the vehicle such that the open tray or tonneau is fully enclosed to provide protection to the cargo carried in the tray or tonneau, and/or to improve the aerodynamic capability of the vehicle.

As most vehicles that have a tray or tonneau are utility vehicles or pick-up trucks, they are often used by workers in the various trades to carry tools and other such equipment required to perform their duties. Thus, by providing a cover over the cargo tray of the vehicle the tools and equipment are protected from the weather, and are also hidden from view, to minimise potential theft of the equipment.

Whilst most existing hard and soft canopies or covers have been effective at performing their desired task of protecting and enclosing the open tray of a vehicle, in order to install such covering systems there is often a need to significantly adapt the vehicle to accommodate the various parts of the canopy system. In some instances the vehicles may require components of the canopy system being welded to the body of the vehicle and permanent reconfiguration of the body of the vehicle to accommodate the parts of the canopy system. This is highly undesirable and can have an adverse effect on the aesthetics of the vehicle, especially if the vehicle is to be used for other purposes that do not require the canopy and if the vehicle is to be resold.

In relation to soft canopy systems, many existing systems require significant attachment mechanisms, such as straps, hooks and the like, to secure the soft material of the walls in position. As such, to open/close conventional soft canopy systems, there is often a need to unfasten/fasten multiple components employed to maintain the walls of the canopy in a taut and secure position. This can take considerable time to do and there is a constant temptation to only secure some of the components which can cause the canopy system to become damaged and loose. This can then result in a canopy that not only looks aesthetically poor, but which also fails to provide an enclosure over the tray to protect cargo that may be present therein.

Thus, there is a need to provide a canopy system for covering a tray or tonneau of a vehicle that can be simply fitted to the vehicle with minimal adaptation of the vehicle required and which simply and effectively opens and closes without the need for multiple securing points.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### SUMMARY

The invention according to one or more aspects is as defined in the independent claims. Some optional and/or preferred features of the invention are defined in the dependent claims.

Accordingly, in one aspect of the invention there may be provided a canopy system for covering a tray of a vehicle comprising a frame mountable to the vehicle so as to extend over the tray of the vehicle, the frame may have supports configured to attach to the vehicle; a cover configured to extend over the frame, the cover may be attachable to at least one of the supports of the frame and having a roof portion, a front portion, opposing side portions and a rear portion, at least one of the opposing side portions and the rear portion being partially detachable from the cover to provide access to the tray of the vehicle. The supports may have bracket members attached to ends thereof and the bracket members may be configured to be supported on top of side walls of the vehicle. The bracket members may be attached to an inner surface of the side walls of the vehicle.

In one embodiment of this aspect of the invention, the supports may be located at each corner of the frame and the bracket members may attach to opposing ends of each of the side walls of the vehicle such that the frame may span the tray of the vehicle.

In another embodiment, the at least one of the opposing side portions and the rear portion may be partially detachable from the cover along sides thereof such that the at least one of the opposing side portions and the rear portion may be lifted to provide access to the tray of the vehicle.

In yet another embodiment, the at least one of the partially detachable opposing side portions and the rear portion may have a pocket formed along a length thereof. The pocket may be configured to receive a rod member therein to extend substantially the length of the at least one of the opposing side portions and the rear portion.

In another embodiment, the rod member may be supported at either end by the bracket members of the frame to extend along a lowermost edge of the opposing side portions and the rear portion when the opposing side portions and the rear portion are fully attached to the cover.

Accordingly, in another aspect of the invention there is provided a canopy system for covering a tray of a vehicle comprising a frame mountable to the vehicle so as to extend over the tray of the vehicle; a cover configured to extend at least partially over the frame, the cover may be attachable to at least one of the supports of the frame and may have a roof portion, a front portion, opposing side portions and a rear portion. At least one of the opposing side portions and the rear portion may be at least partially detachable from the cover to provide access to the tray of the vehicle. At least one of the partially detachable opposing side portions and the rear portion may have a pocket formed along a length thereof, the pocket may be configured to receive a rod member therein to extend substantially along the length of the at least one of the opposing side portions and the rear portion. The frame may have supports configured to attach to the vehicle.

In an embodiment of this aspect of the invention, the rod member may be supported at either end by bracket members of the frame to extend along a lowermost edge of the opposing side portions and the rear portion when the opposing side portions and the rear portion are fully attached to the cover.

In yet another embodiment, the bracket members may be configured to attach to ends of at least one of the supports of the frame and the bracket members may be configured to be supported on top of side walls of the vehicle to attach the frame to an inner surface of the side walls of the vehicle.

Additional aspects related to this disclosure are set forth, in part, in the description which follows, and, in part, will be obvious from the description, or may be learned by practice of this disclosure.

### BRIEF DESCRIPTION OF THE DRAWINGS

The invention may be better understood from the following non-limiting description of preferred embodiments, in which:

FIG. 1 is a rear perspective view of a vehicle having an open tray suitable for receiving the canopy system of the present invention;

FIG. 2 is a rear perspective view of the vehicle of FIG. 1 with a canopy system according to an embodiment of the present invention fitted thereto;

FIG. 3 is a perspective view of the frame members of the canopy system of the present invention;

FIG. 4 is a perspective view of an internal roof structure of the canopy system of the present invention;

FIG. 5 is a perspective view showing the roof structure of FIG. 4 positioned over the tray of a vehicle for fitting of the canopy system;

FIG. 6 is a perspective view showing the manner in which the bracket members of the roof structure of FIG. 5 are fitted to the vehicle;

FIG. 7 is a perspective view showing the manner in which a cover member of the canopy system of the present invention is mounted to the roof structure;

FIG. 8 is a cross-sectional side view of the canopy system of the present invention showing the manner in which a front flap of the cover member of FIG. 7 is attached to the vehicle;

FIG. 9 is a perspective view of a retainer member attached to the front flap of the cover member as shown in FIG. 8;

FIG. 10 is a side view of the retainer member of FIG. 9;

FIG. 11 is a perspective view of the canopy system of the present invention with the rod members attached to the cover flaps;

FIG. 12 is a perspective view a rod member of FIG. 11; and

FIG. 13 is a perspective view of the canopy system of the present invention with the flap members rolled into an open position.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

The canopy system of the present invention will be described below in relation to its application to cover a tray or tonneau of a utility or pick-up vehicle. However, it will be appreciated that the canopy system could be equally employed to cover or enclose a variety of different open areas on vehicles, including land vehicles and water vehicles, as will be appreciated by those skilled in the art.

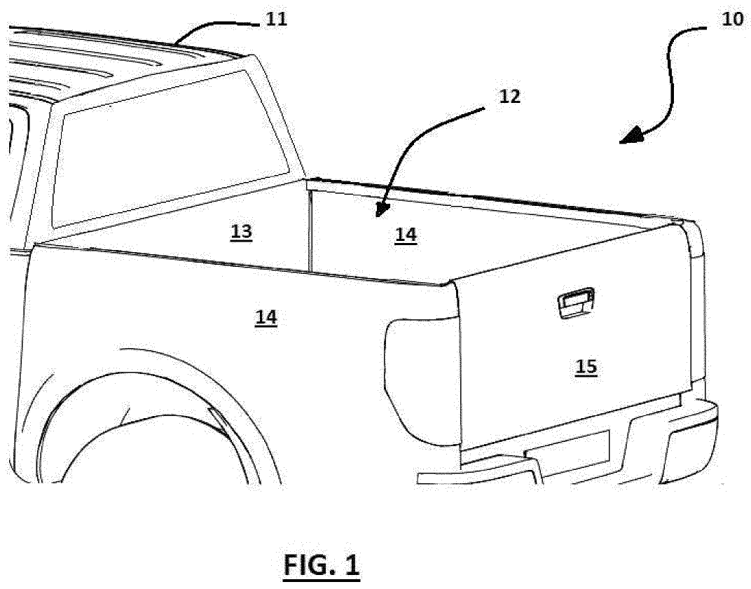

Referring to FIG. 1, a vehicle 10 suitable for use with the canopy system of the present invention is depicted. The vehicle 10 comprises an open tray or tonneau 12 which may be used to store cargo as required. The open tray 12 is typically located behind the cabin 11 of the vehicle 10 and is defined by a front wall 13, side walls 14 and a rear wall 15. The rear wall 15 is in the form of a tailgate that can be lowered to access the surface of the tray 12 to load/unload the cargo from the vehicle 10.

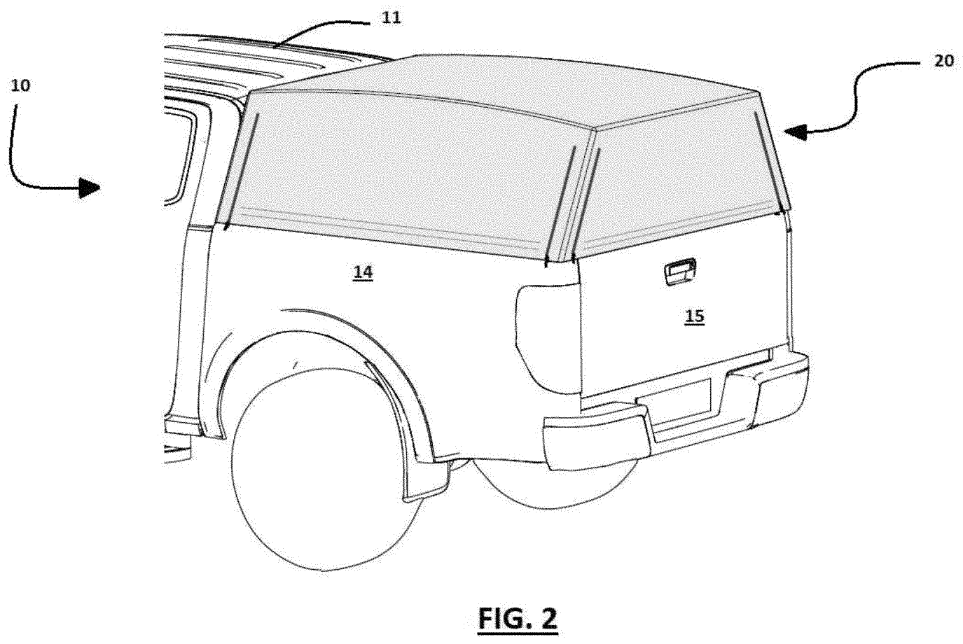

FIG. 2 depicts the canopy system 20 of the present invention fitted to enclose the open tray 12 of the vehicle 10. As will become apparent in the description below, the canopy system 20 functions not only to be fitted over the open tray 12, but is also shaped to extend the vertical height of the open tray 12 so as to accommodate cargo that is higher than the height of the walls 13, 14 and 15 of the open tray 12. In the embodiment as shown the canopy system 20 is formed of a material that prevents viewing into the tray when in the closed position. However, it will be appreciated that the canopy system 20 may have windows formed from a see-through material, such as plastic, to provide a view into the tray 12 of the vehicle.

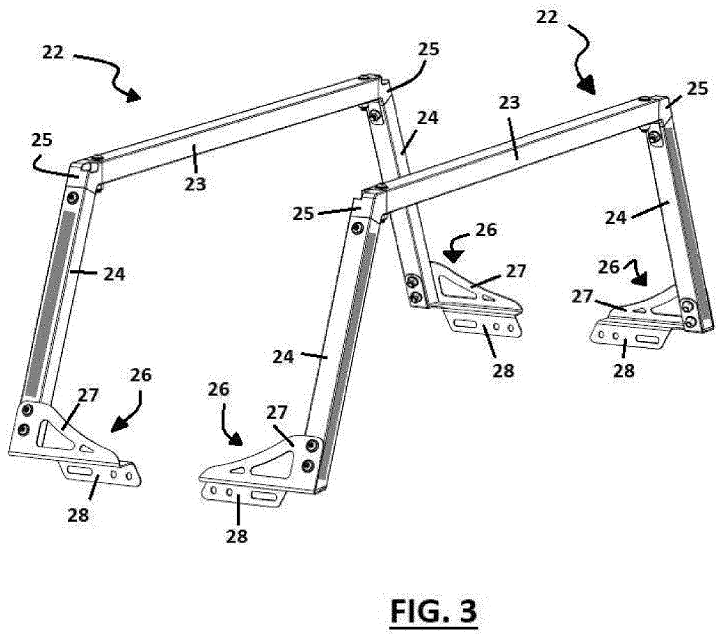

Referring to FIG. 3, the canopy system 20 comprises a pair of frame members 22 that are configured to be mounted to the vehicle at a front and rear of the tray 12. The frame members 22 give structure to the canopy system 20 and each comprise a horizontal beam 23 mounted between a pair of supports 24. The supports 24 extend outwardly from opposing ends of the beam 23 in an angular manner as shown.

Each of the supports 24 and the beams 23 are preferably made from a rectangular hollow section (RHS) of metal, such as aluminium or steel. The supports 24 connect to the ends of the beam 23 by way of connectors 25 that are configured to be received within the hollow associated ends of the support 24 and the beam 23, to provide the angular orientation of the support 24 with respect to the beam 23. The connectors 25 are attached to the ends of the beam 23 and supports 24 by way of mechanical fasteners, such as screws, rivets or the like. It will be appreciated that in an alternative embodiment, the beams 23 and supports 24 may be formed from a plastic material.

Bracket members 26 are mounted to the free ends of the supports 24, as depicted in FIG. 3. The bracket members 26 extend substantially orthogonal to the supports 24, and are directed inwardly, toward the other frame member 22, as shown. The bracket members 26 comprise a brace portion 27 that has a triangular configuration that is configured to provide support to the frame member 22 when in the mounted position. A mount portion 28 extends from an under side of the brace portion 27 in a substantially vertical manner, to facilitate attachment of the bracket member 26 to the vehicle 10. The mount portion 28 has a series of holes 29 formed therein to accommodate screws for attachment to the vehicle 10, in a manner to be described in more detail below.

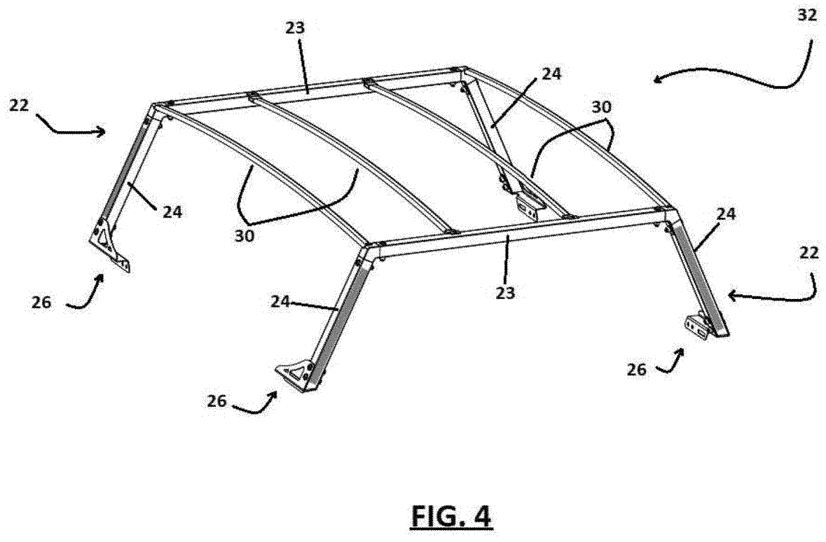

As is shown in FIG. 4, a plurality of struts 30 are provided to extend orthogonally between the beams 23 of the frame members 22. The struts 30 are attached to the beams at their opposing ends by way of screws or the like, such that the struts 30 extend between the frame members 22 in a substantially parallel manner. Struts 30 are positioned to extend between the frame members at each end of the beams 23, with two centrally located struts positioned in an equi-spaced manner between the end struts 30. The arrangement as shown in FIG. 4 forms a roof structure 32 for the canopy system 20. It will be appreciated that whilst the embodiment depicted in FIG. 4 shown four struts 30 extending between the frame members 22, the number of struts 30 employed to form the roof structure 32 of the canopy system 20 may vary depending upon the size of the canopy and the requirements of the user.

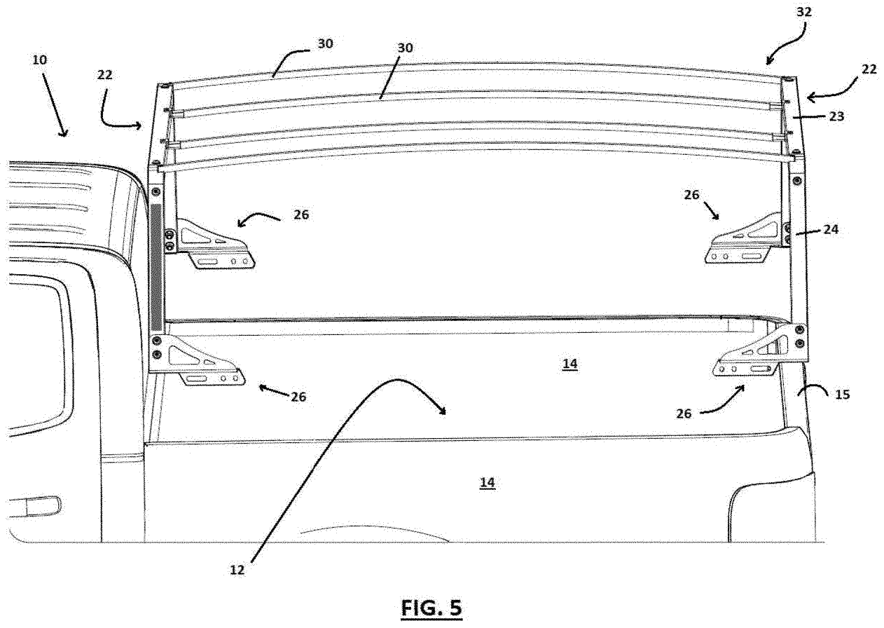

As is shown in FIG. 5, the roof structure 32 of the canopy system 20 is configured such that it extends the length and breadth of the tray 12, to fully enclose the tray 12. To accommodate different sized trays 12, the length of the beams 23 and the struts 30 can be varied, thereby varying the length and breadth of the roof structure 32 to fit any sized tray.

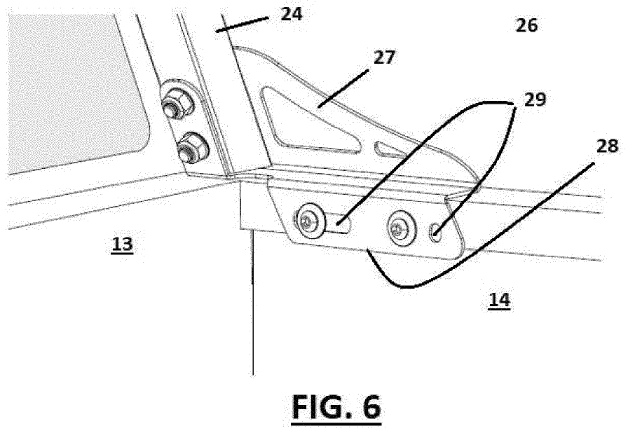

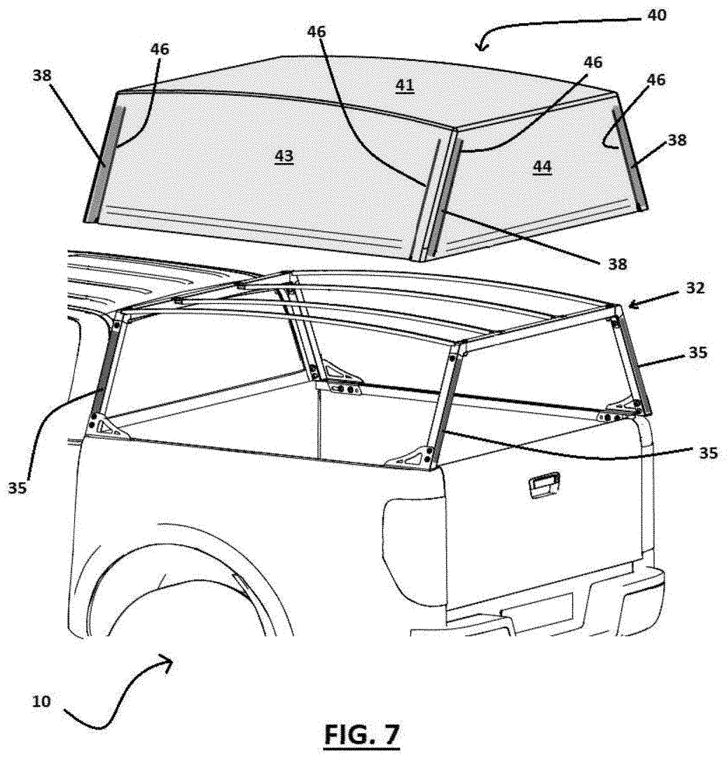

To secure the roof structure 32 to the vehicle 10, the roof structure 32 is positioned in the manner as shown in FIG. 5, such that the bracket members 26 are located on the each of the ends of the side walls 14 of the vehicle 10. In this position, the brace portion 27 of the bracket members 26 is supported on the upper edge of the side wall 14 with the mount portion 28 extending long the inner surface of the side wall 14, as is shown more clearly in FIG. 6. Holes can be drilled in the upper surface of the side wall 14 of the vehicle 10 to align with the holes 29 formed in the mount portion 28 of the bracket member 26. Screws or the like can then be used to pass through the holes 29 and attach the mount portion 28 of the bracket member 26 to the vehicle. This is repeated at each of the four bracket members 26 such that the roof structure 32 of the canopy system 20 is secured in place on the vehicle as is shown in FIG. 7.

A cover member 40 is provided to fit over the roof structure 32, as is shown in FIG. 7. The cover member 40 is formed from a soft material, such as a canvas, plastic or similar material that is flexible and durable. The cover member 40 is shaped to substantially conform to the shape of the roof structure 32 and has attachment members 38 formed along an inside wall of the material to engage with attachment members 35 formed on the outer surfaces of the supports 24 of the roof structure 32. In this regard, each of the supports 24 of the front frame member 22 has an attachment member 35 mounted on the outer surface thereof and each of the supports of the rear frame member 22 has an attachment member 35 attached to the rear surface thereof. The attachment members 35 and 38 may be in the form of hook and loop fasteners to securely locate the cover member 40 on the roof structure 32. It will be appreciated that other attachment means may also be employed, such as press-studs, magnets, adhesive strips and the like.

Referring to FIG. 7, the cover member 40 comprises a roof portion 41 that forms the roof of the canopy system 20. The roof portion 41 extends over the struts 30 and conforms to the shape of the struts 30, to define a substantially flat surface with a slight curve to facilitate run-off of rain and the like. A front flap 42 extends from a front edge of the roof portion 41 to the front wall 13 of the vehicle 10, to extend between the cabin 11 and the tray 12. Side flaps 43 extend from the sides of the roof portion 41 to the side walls 14, and a rear flap 44 extends from a rear edge of the roof portion 41 to the tailgate 15.

To fit the cover member 40 on the roof structure 32, the attachment members 38 of the cover member 40 and the attachment members 35 of the roof structure 32 are first aligned and engaged. This results in a support portion 45 of the cover member 40 extending over each of the supports 24 of the roof structure 32, with the front flap 42, side flaps 43 and rear flap 44 extending between these support portions 45. The side flaps 43 and rear flap 44 connect to the support portions by way of a zipper arrangement 46, which controls access to the interior of the tray 12 of the vehicle 10 via the side flaps 43 and rear flap 44.

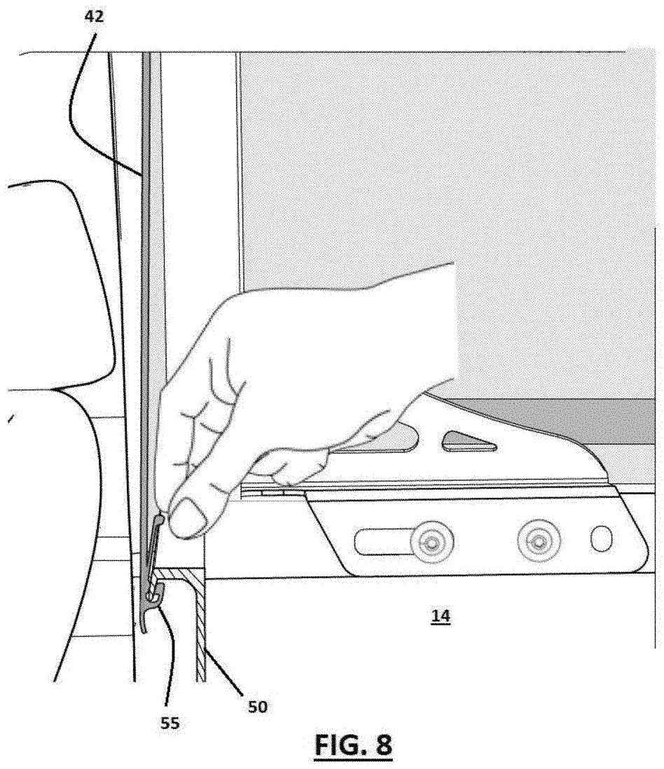

The front flap 42 is secured along its bottom edge to the front surface of the front wall 13 of the vehicle 10, in the manner as depicted in FIG. 8. A hook member 50 is mounted to the front surface of the front wall 13 of the vehicle 10, and extends across the front wall 13 between the cabin 11 and the tray 12. A retainer member 55 is mounted to extend along the edge of the front flap 42, to engage with the hook member 50 such that the front flap 42 is securely held in position against the front wall 13 along its length.

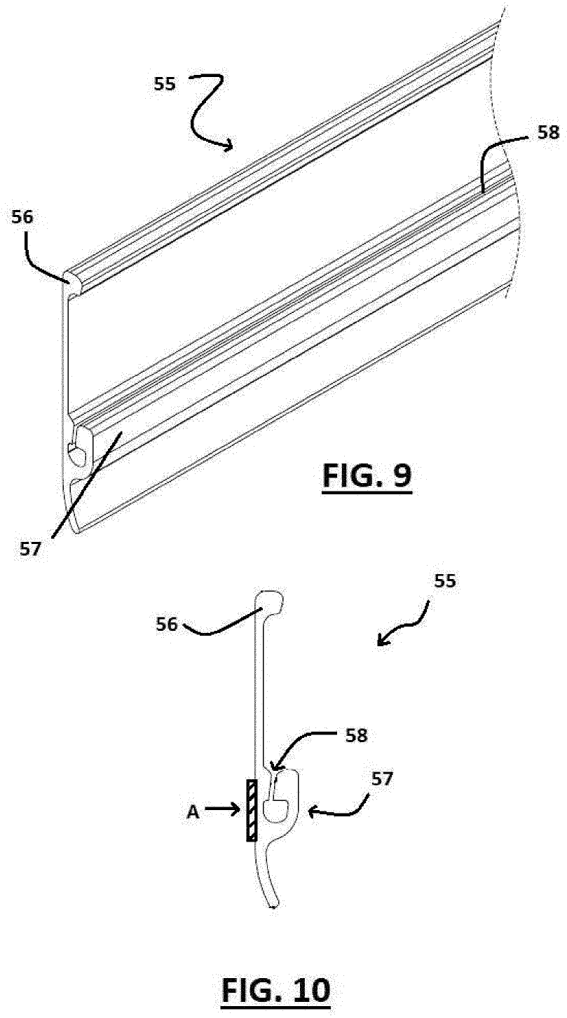

The retainer member 55 is shown in isolation in FIGS. 9 and 10. The retainer member 55 is attached along the bottom edge of the front flap 42 at point A, by way of an adhesive or welding process. The retainer member 55 has a gripping portion 56 that is able to be gripped by a user, in the manner as shown in FIG. 8, to align an opening 58 of a clasp portion 57 of the retainer member 55 to receive the hook member 50 mounted on the vehicle 10. The clasp portion 57 is then able to engage with the hook member 50 along the entire length of the front flap 42 to perform a sealed engagement between the front flap 42 and the vehicle 10.

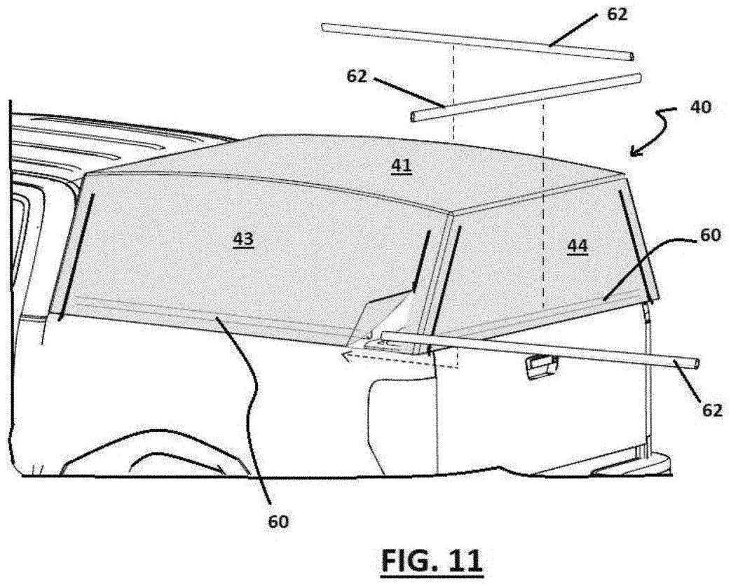

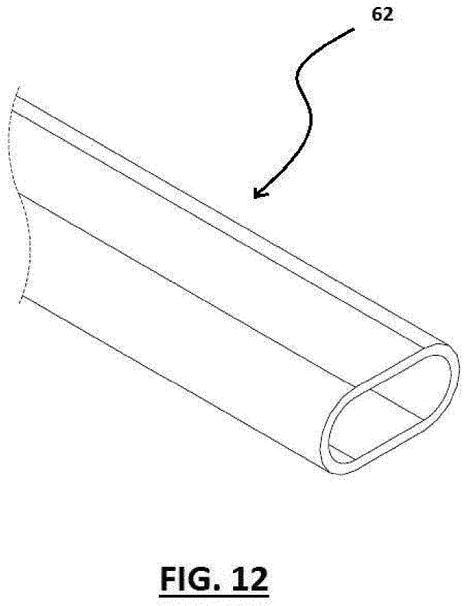

As is show in FIG. 11, each of the side flaps 43 and the rear flap 44 of the cover member 40 have a pocket 60 formed along an inner surface of a lower edge thereof. The pocket 60 is configured to snugly receive a rod 62 therein such that the rod 62 extends substantially the length of the side flaps/rear flaps, as shown. The rod 62 is preferable made from a metal, such as aluminium, and is hollow and has an ovate profile, as is shown in isolation in FIG. 12. The rod 62 functions to stiffen the lower edge of the side flaps 43 and rear flap 44 to ensure that the cover member is retained on the roof structure 32 in a taught and secure manner.

It will be appreciated that when each of the zipper arrangements 46 are closed, the flaps 43, 44 will become taught against the support portion 46 of the cover member 40. The ends of the rods 62 are supported on the surface of the brackets 26 such that they extend along the surface of the vehicle 10 but do not contact the vehicle when the flaps 43, 44 are closed. Thus, the rods 62 maintain a secure tight fit of the lower edge of the flaps over the surface of the vehicle between the support portions 46 of the cover member 40. Such an arrangement will ensure the cover remains securely in position during transport without the need for multiple straps and studs fitted to the external surfaces of the vehicle to maintain the cover 40, and flaps, in position.

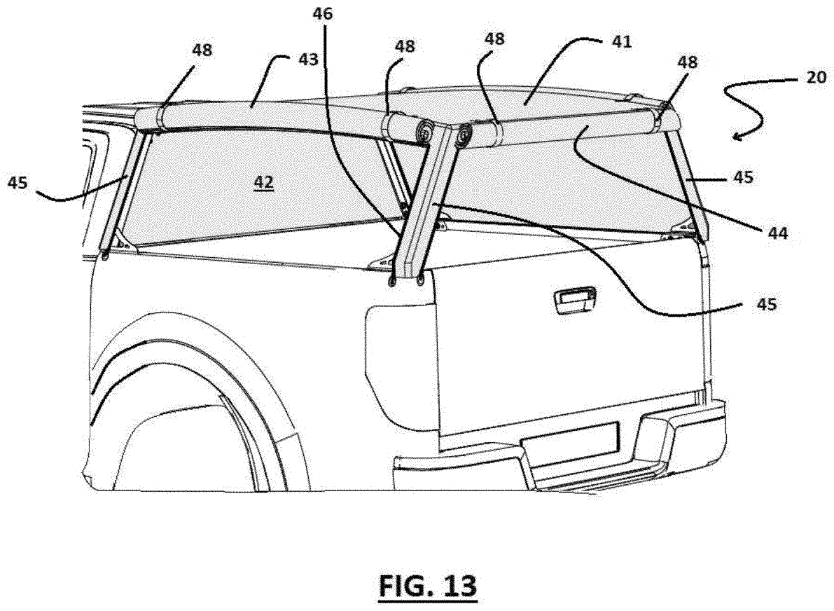

Referring to FIG. 13, the canopy system 20 of the present invention can be readily opened to provide access into the tray 12 of the vehicle as required. The zipper arrangements 46 are provided at each ends of the side flaps 43 and the rear flap 44 and when the zipper arrangements 46 are opened in the manner shown in FIG. 13, the flaps 43 and 44 can be rolled into an upward position. Stay members are attached to the inside surface of the roof portion 41 of the cover member 40 such that when the flaps 43, 44 are rolled into a storage position, the stay members can be positioned over the rolled flaps to retain them in the position. The ends of the stay members 48 may have magnets provided therein that attract to magnets provided in the roof portion 41 of the cover member 40, to secure the stay members 38 in position. However, other fastening means, such as press-studs and the like, may also be employed. It will be appreciated that the cover member 40, when positioned on the roof structure 32, provides a simple and effective means for accessing the internal space thereof, as may be required by the user.

It will be appreciated that the canopy system of the present invention provides a simple and effective cover for an open tray of a vehicle completely removes the need for welding and other significant adaptations of the vehicle to fit the canopy system and retain it in a taut position. The canopy system comprises an internal frame structure having brackets that are positioned on the corners of the tray of the vehicle, which can be simply attached to an inside rim of the tray to support the canopy system in position. The flap members of the cover system have rod members fitted within pockets adjacent the lower edge thereof which function to stiffen and retain the flap members of the cover of the canopy in a taut position, without the need for multiple ties and other attachment members. Thus, the canopy system of the present invention enables a canopy to be fitted to a vehicle without the need to alter the internal surfaces of the vehicle. This maintains the aesthetics of the vehicle and enables the canopy system to be removed from the vehicle as required, without showing any external signs or markings of the canopy system, which improves the resale value of the vehicle.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the canopy system uppermost.

It will be appreciated by those skilled in the art that many modifications and variations may be made to the methods of the invention described herein without departing from the spirit and scope of the invention.

1. A canopy system for covering a tray of a vehicle comprising:
a frame mountable to the vehicle so as to extend over the tray of the vehicle, the frame having supports configured to attach to the vehicle;
a cover configured to extend over the frame, the cover being attachable to at least one of the supports of the frame and having a roof portion, a front portion, opposing side portions and a rear portion, at least one of the opposing side portions and the rear portion being partially detachable from the cover to provide access to the tray of the vehicle;
wherein the supports have bracket members attached to ends thereof and the bracket members are configured to be supported on top of side walls of the vehicle, wherein the bracket members are attached to an inner surface of the side walls of the vehicle.

2. A canopy system according to claim 1, wherein the supports are located at each corner of the frame and the bracket members attach to opposing ends of each of the side walls of the vehicle such that the frame spans the tray of the vehicle.

3. A canopy system according to claim 1, wherein the at least one of the opposing side portions and the rear portion are partially detachable from the cover along their sides such that the at least one of the opposing side portions and the rear portion can be lifted to provide access to the tray of the vehicle.

4. A canopy system according to claim 3, wherein the at least one of the partially detachable opposing side portions and the rear portion have a pocket formed along a length thereof, the pocket configured to receive a rod member therein to extend substantially the length of the at least one of the opposing side portions and the rear portion.

5. A canopy system according to claim 4, wherein the rod member is supported at either end by the bracket members of the frame to extend along a lowermost edge of the opposing side portions and the rear portion when the opposing side portions and the rear portion are fully attached to the cover.

6. A canopy system for covering a tray of a vehicle comprising:
a frame mountable to the vehicle so as to extend over the tray of the vehicle, the frame having supports configured to attach to the vehicle;
a cover configured to extend at least partially over the frame, the cover being attachable to at least one of the supports of the frame and having a roof portion, a front portion, opposing side portions and a rear portion, wherein at least one of the opposing side portions and the rear portion are at least partially detachable from the cover to provide access to the tray of the vehicle;
wherein at least one of the partially detachable opposing side portions and the rear portion have a pocket formed along a length thereof, the pocket is configured to receive a rod member therein to extend substantially along the length of the at least one of the opposing side portions and the rear portion.

7. A canopy system according to claim 6, wherein the rod member is supported at either end by bracket members of the frame to extend along a lowermost edge of the opposing side portions and the rear portion when the opposing side portions and the rear portion are fully attached to the cover.

8. A canopy system according to claim 7, wherein the bracket members are configured to attach to ends of at least one of the supports of the frame and the bracket members are configured to be supported on top of side walls of the vehicle to attach the frame to an inner surface of the side walls of the vehicle.
